(19) United States
(12) Patent Application Publication
(10) Pub. No.: US 2009/0258193 A1
(43) Pub. Date: Oct. 15, 2009

(54) MULTILAYERED CERAMIC SUBSTRATE

(75) Inventors: Young Nam HWANG, Suwon (KR); Young bok Yoon, Yongin (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/251,840

(22) Filed: Oct. 15, 2008

(30) Foreign Application Priority Data
Apr. 15, 2008 (KR) 10-2008-0034848

(51) Int. Cl. B32B 3/02; B32B 7/02

(52) U.S. Cl. 428/172; 428/212

(57) ABSTRACT

There is provided a multilayered ceramic substrate where a groove is formed in a intermediate stack having a relatively big thermal expansion coefficient or a step is formed at an edge portion of the intermediate stack so that cracks occurring due to differences in the thermal expansion coefficient among stacks is prevented from spreading to the edge portion, thereby inhibiting occurrence of edge cracks.

### CROSS-REFERENCE TO RELATED APPLICATIONS

This application claims the priority of Korean Patent Application No. 2008-0034848 filed on Apr. 15, 2008, in the Korean Intellectual Property Office, the disclosure of which is incorporated herein by reference.

### BACKGROUND OF THE INVENTION

1. Field of the Invention

The present invention relates to a multilayered ceramic substrate including ceramic green sheets stacked, and more particularly, to a low-temperature co-fired multilayered ceramic substrate.

2. Description of the Related Art

With greater efforts made to achieve smaller and more cost-effective portable electronic devices, studies for integrating passive devices constituting the electric devices have been conducted actively with ardent interest.

Active devices are mostly high-density integrated circuits based on the silicon technology and have been incorporated into only several chip parts. Meanwhile, passive devices such as a resistor, a capacitor and an inductor have been hardly integrated and individually attached onto a circuit board by soldering.

Therefore, a demand for integrating the passive devices has been increased to reduce the size of the passive devices and enhance performance and reliability thereof. As a method for solving this problem, a low temperature co-fired ceramics (LTCC)-based integration technology has been vigorously studied.

Generally, in the LTCC technology, a metal is applied on a glass-mixed ceramic substrate, and a plurality of ceramic green sheets each having a metal electrode formed thereon are stacked and pressurized. Then, the ceramic green sheets are subjected to co-firing at a low temperature of 800° C. to 1000° C. to form a multilayered substrate.

FIG. 1 is a schematic view illustrating a conventional low-temperature co-fired ceramic substrate.

As shown, an organic binder and a plasticizer are added to a powder having a ceramic power and a sintered agent mixed therein to prepare a slurry. Then, the slurry is formed using tape casting and then cut into a predetermined size to manufacture green sheets S.

The green sheets S are provided in plural numbers to manufacture a multilayered substrate. Each of the green sheets S may be provided thereon with an internal connection terminal. The internal connection terminal is formed by filling a conductive paste in a via hole perforated in the green sheet to electrically connect upper and lower ones of the green sheets. Also, the each green sheet may be provided with inner electrodes by screen-printing a conductive paste which is a high melting point metal.

Moreover, the green sheets S prepared as above are stacked in a necessary number, and heated and pressurized to form stacks.

Meanwhile, the green sheets S are different in physical properties such as permittivity, permeability, or thermal expansion coefficient due to differences in mixed materials added in preparing the slurry. Therefore, as shown in FIG. 2, in order to form a multilayered ceramic substrate, stacks 20 and 30 with low thermal expansion coefficients are disposed above and below a stack with a relatively bigger thermal expansion coefficient, respectively to be horizontally symmetrical with each other.

However, in the multilayered ceramic substrate 1 with this multilayered structure, an intermediate stack 10 with a big thermal expansion coefficient suffers tensile stress due to rapid temperature change during a sintering process. This tensile stress arising from differences in the thermal expansion coefficient as described above may disadvantageously cause cracks c to the intermediate stack 10.

Furthermore, cracks occurring in the intermediate stack 10 may spread to an edge portion of the substrate to cause edge cracks. This induces moisture to be infiltrated into the substrate to lead to defects in the product and undermine reliability thereof.

### SUMMARY OF THE INVENTION

An aspect of the present invention provides a multilayered ceramic substrate in which a groove is formed in a intermediate stack having a relatively big thermal expansion coefficient or a step is formed at an edge portion of the intermediate stack to block cracks caused by differences in the thermal expansion coefficient among stacks from spreading to the edge portion, thereby inhibiting occurrence of edge cracks.

According to an aspect of the present invention, there is provided a multilayered ceramic substrate including: a first stack formed of ceramic green sheets having a first thermal expansion coefficient; a second stack formed of ceramic green sheets having a second thermal expansion coefficient different from the first thermal expansion coefficient, the second stack stacked on one of upper and lower surfaces of the first stack; and a buffer part defined by a machined portion in at least one of the upper and lower surfaces of the first stack so as to prevent a crack occurring inside the first stack from spreading to an edge portion of the first stack to cause an edge crack.

The multilayered ceramic substrate may further include a third stack formed of ceramic green sheets having a third thermal expansion coefficient different from the first thermal expansion coefficient, the third stack stacked on the other one of the upper and lower surfaces of the first stack.

The first stack may have a thermal expansion coefficient greater than a thermal expansion coefficient of the second stack.

The first stack may have a thermal expansion coefficient greater than a thermal expansion coefficient of the third stack.

The second thermal expansion coefficient of the second stack may be substantially identical to the third thermal expansion coefficient of the third stack.

The buffer part may include a groove provided in the at least one of the upper and lower surfaces of the first stack to induce crack occurrence.

The groove may be formed inside an outer periphery of the first stack.

The buffer part may have a thermal expansion coefficient identical to the first thermal expansion coefficient, and includes an auxiliary layer stacked on the at least one of the upper and lower surfaces of the first stack.

The buffer part may include a groove defined by a stack of the auxiliary layer to prevent crack occurrence.

The auxiliary layer may include at least one of the ceramic green sheets of the first stack.

The buffer part may include a step formed such that the edge portion of the first stack has a thickness greater than an inner portion thereof.

The buffer part may include a groove formed in the at least one of the upper and lower surfaces of the first stack to induce crack occurrence, and a step formed such that the edge portion of the first stack has a thickness greater than an inner portion thereof.

The groove may be formed inside the edge portion of the first stack where the step is formed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating general low-temperature co-fired ceramic substrates;

FIG. 2A is a cross-sectional view illustrating cracks generated in a first stack in a multilayered ceramic substrate where the ceramic substrates of FIG. 1 are stacked;

FIG. 2B is a plan view illustrating the first stack of FIG. 2A;

FIG. 3A is a cross-sectional view illustrating grooves formed in a first stack in a multilayered ceramic substrate according to an exemplary embodiment of the invention;

FIG. 3B is a cross-sectional view illustrating another substrate where grooves are formed in a first stack;

FIG. 3C is a cross-sectional view illustrating grooves formed in a first stack;

FIG. 3D is a plan view illustrating a first stack having grooves formed therein;

FIG. 4A is a cross-sectional view illustrating a step formed on a first stack in a multilayered ceramic substrate according to an exemplary embodiment of the invention;

FIG. 4B is a plan view illustrating the first stack of FIG. 4A;

FIG. 5A is a cross-sectional view illustrating grooves and a step formed in a first stack in a multilayered ceramic substrate according to an exemplary embodiment of the invention; and

FIG. 5B is a plan view illustrating the first stack of FIG. 5A.

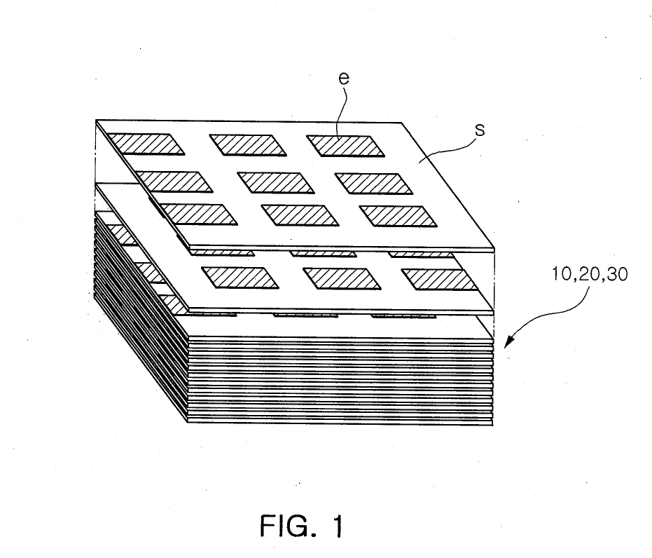

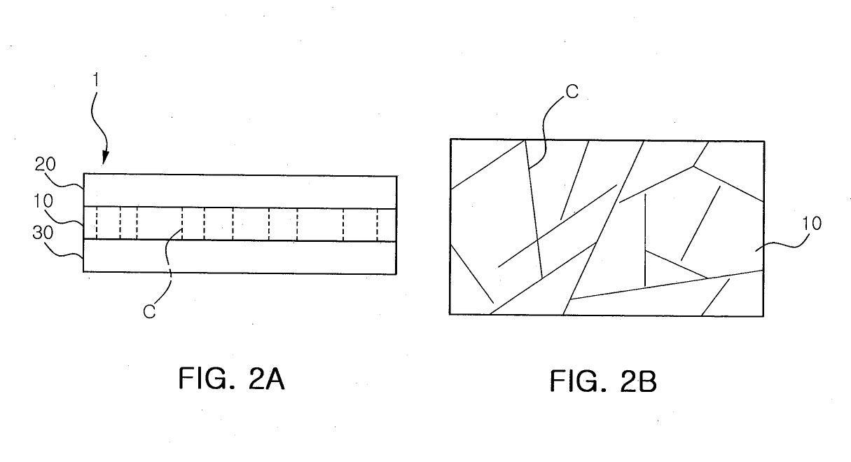

### DETAILED DESCRIPTION OF THE PREFERRED EMBODIMENT

Exemplary embodiments of the present invention will now be described in detail with reference to the accompanying drawings.

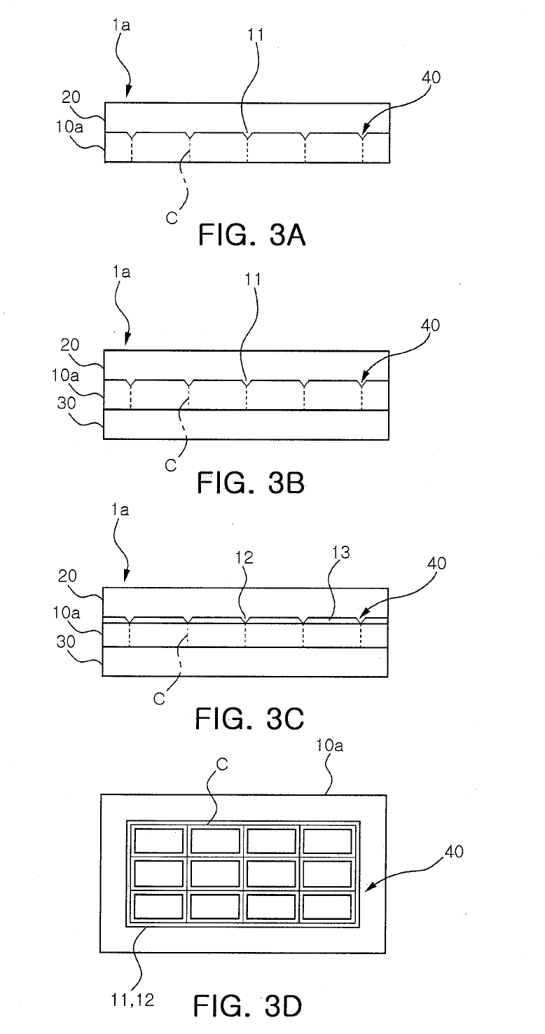

First, a multilayered ceramic substrate will be described with reference to FIG. 3.

FIG. 3 is a schematic view illustrating a multilayered ceramic substrate la according to an exemplary embodiment of the invention, in which FIGS. 3 A and B are cross-sectional views illustrating grooves formed in a first stack, FIG. 3C is a cross-sectional view illustrating grooves formed in a first stack, and FIG. 3D is a plan view illustrating a first stack having grooves formed therein.

As shown in FIG. 3A, the multilayered ceramic substrate 1a of the present embodiment includes a first stack 10a, a second stack 20 and a buffer part 40. The second stack 20 is disposed on one of an upper surface and lower surface of the first stack 10a.

Also, as shown in FIG. 3B, the multilayered ceramic substrate 1a includes a first stack 10a, a second stack 20, a third stack 30 and a buffer part 40. The second stack 20 may be formed on the upper surface of the first stack 10a and the third stack 30 may be formed on the lower surface of the first stack 10a.

The stacks 10a, 20, and 30 are formed by stacking a plurality of ceramic green sheets S. The stacks may be identical to or different from one another in physical properties according to physical properties of the stacked green sheets S.

That is, the green sheets S are classified by the thermal expansion coefficient (CTE) and corresponding ones of the green sheets S with identical expansion coefficients are stacked to form the respective stacks 10a, 20, and 30 with different thermal expansion coefficients.

The first stack 10a may have a thermal expansion coefficient different from thermal expansion coefficients of the second stack 20 and third stack 30, respectively. However, particularly, the second stack 20 and the third stack 30 may have thermal expansion coefficients substantially identical to each other.

Therefore, the first stack 10a and the second stack 20 have a different thermal expansion coefficient from each other and the first stack 10a and the third stack 30 have a different thermal expansion coefficient from each other. Also, the second stack 20 and the third stack 30 may have a thermal expansion coefficient identical to or different from each other.

Furthermore, the first stack 10a has a first thermal expansion coefficient greater than a second thermal expansion coefficient of the second stack 20 and a third thermal expansion coefficient of the third stack 30, respectively.

Meanwhile, as in FIG. 3A or FIG. 3B, the buffer part 40 is formed by machining the upper surface of the first stack 10a so as to prevent cracks generated inside the first stack 10a from spreading to an edge portion of the first stack to cause occurrence of edge cracks.

In the present embodiment, the buffer part 40 includes grooves 11 formed in the upper surface of the first stack 10a to induce occurrence of cracks c. Alternatively, the grooves 11 may be formed in the lower surface of the first stack 10a.

Also, to form the grooves 11, the surface of the first stack 10a may be machined, for example, by irradiating a laser beam onto the surface of the first stack 10a, but not limited thereto.

The grooves 11 may be formed in consideration of circuit patterns (e). The grooves 11 are formed inside an outer periphery of the first stack 10a to be spaced apart from the outer periphery at a predetermined distance.

Moreover, as shown in FIG. 3C, the buffer part 40 is formed of a material identical to the first stack 10a, and also has a thermal expansion coefficient identical to the first stack 10a. The buffer part 40 may include an auxiliary layer 13 formed on at least one of the upper and lower surfaces of the first stack.

Also, the buffer part 40 may include grooves formed by stacking the auxiliary layer 13 to induce occurrence of cracks c. Here, the grooves 12 may be formed by machining a surface of the buffer part 40 inside the outer periphery of the first stack 10a.

That is, the auxiliary layer 13 formed of a material identical to the first stack 10a and also having a thermal expansion coefficient identical to the first stack 10a is additionally stacked on the first stack 10a and the grooves 12 are formed therein. Alternatively, the auxiliary layer 13 having the grooves 12 formed therein may be additionally stacked.

Here, the auxiliary layer 13 may be formed by stacking at least one of the green sheets S constituting the first stack 10a.

As described above, the grooves 11 or 12 are formed to arbitrarily design such that cracks c occur regularly along the grooves 11 or 12. Also, as shown in FIG. 3D, the grooves 11 or 12 allow the cracks to occur only inside the stacks 10 while blocking the cracks from spreading to edge portions of the stacks 10.

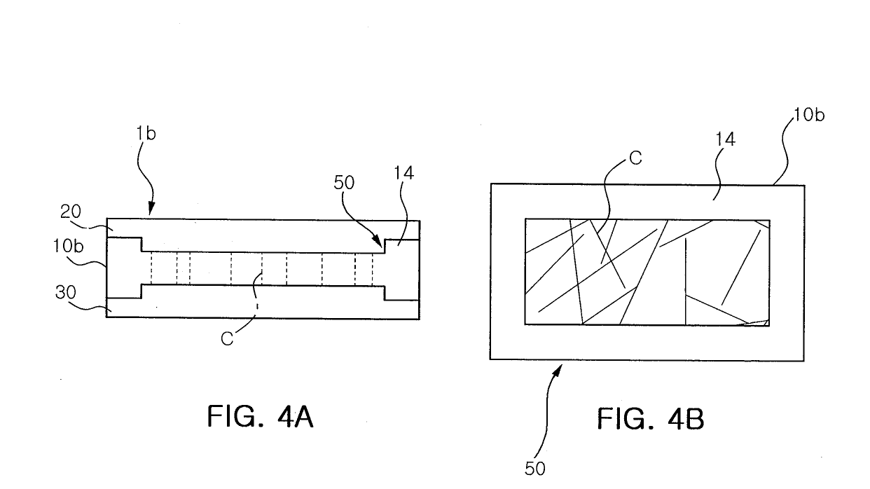

A multilayered ceramic substrate according to an exemplary embodiment of the invention will be described with reference to FIGS. 4A and 4B.

In the embodiment of FIGS. 4A and 4B, the multilayered ceramic substrate 1b is configured in a substantially identical manner to the embodiment of FIG. 3.

However, the embodiment of FIG. 4 is different from the embodiment of FIG. 3 in terms of a detailed construction of the first stack. Thus, hereinafter, overlapping parts with the previous embodiment will be omitted and only construction of the first stack will be mainly described.

As shown in FIG. 4, the multilayered ceramic substrate 1b of the present embodiment includes a first stack lob, a second stack 20, a third stack 30 and a buffer part 50. Also, a second stack 20 is stacked on an upper surface of the first stack 10b and a third stack 30 is stacked on a lower surface of the first stack 10b.

Although not illustrated, alternatively, the multilayered ceramic substrate 1b of the present embodiment includes a first stack lob, a second stack 20 and a buffer part 50. The second stack 20 may be formed on one of the upper and lower surfaces of the first stack 10b.

The stacks 10b, 20 and 30 have respective thermal expansion coefficients identical to the previous embodiment and thus will not be described further.

In the present embodiment, the buffer part 50 includes a step 14 formed such that an edge portion of the first stack 10b has a thickness greater than a thickness of an inner portion thereof.

The step 14 may be formed by stacking at least one of green sheets S constituting the first stack 10b along the edge portion of the first stack 10b.

This allows cracks c generated inside the first stack 10b from spreading to the edge portion of the first stack 10b.

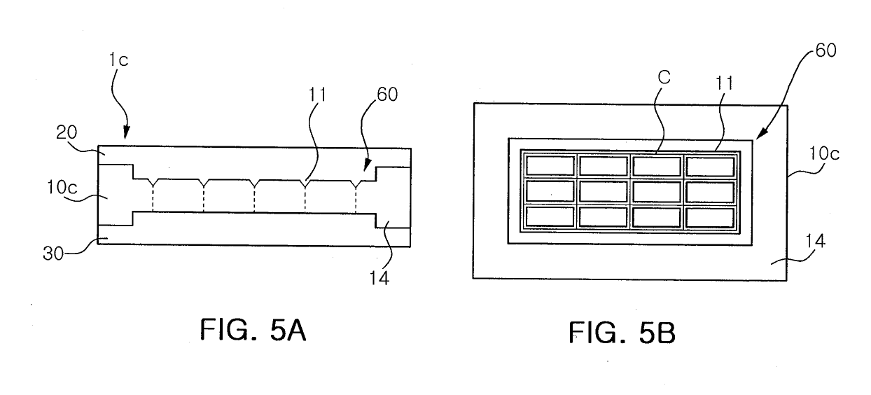

Meanwhile, a multilayered ceramic substrate according to another exemplary embodiment of the invention will be described with reference to FIGS. 5A and 5B.

In the embodiment of FIGS. 5A and 5B, the multilayered ceramic substrate 1c is configured in a similar manner to the embodiment of FIG. 3 and construction of a first stack will be mainly described while the overlapping parts are omitted.

As shown in FIG. 5, the multilayer ceramic substrate 1c of the present embodiment includes a first stack 10c, a second stack 20, a third stack 30 and a buffer part 60. A second stack 20 is stacked on an upper surface of the first stack 10c and a third stack 30 is stacked on a lower surface of the first stack 10c.

In the present embodiment, the buffer part 60 includes grooves 11 formed in the upper surface of the first stack 10c to induce occurrence of cracks c and a step 14 formed with a predetermined thickness along an edge portion of the first stack 10c such that the edge portion of the first stack has a thickness greater than an inner portion thereof.

Here, the grooves 11 may be formed inside the edge portion of the first stack 10c where the step 14 is formed.

As described above, the grooves are provided in at least one of the upper and lower surfaces of the first stack disposed between the second stack and the third stack. Also, the step is formed with a predetermined thickness along the edge portion of the first stack to prevent inner cracks from spreading to the edge portion of the first stack and thus reduce defects by preventing infiltration of moisture.

As set forth above, according to exemplary embodiments of the invention, cracks generated by differences in the thermal expansion coefficient when the temperature changes during sintering are prevented from spreading to an edge portion of a substrate, thereby inhibiting infiltration of moisture. Accordingly, this reduces defects in the product and enhances reliability thereof.

While the present invention has been shown and described in connection with the exemplary embodiments, it will be apparent to those skilled in the art that modifications and variations can be made without departing from the spirit and scope of the invention as defined by the appended claims.

What is claimed is:

1. A multilayered ceramic substrate comprising:
a first stack formed of ceramic green sheets having a first thermal expansion coefficient;
a second stack formed of ceramic green sheets having a second thermal expansion coefficient different from the first thermal expansion coefficient, the second stack stacked on one of upper and lower surfaces of the first stack; and
a buffer part defined by a machined portion in at least one of the upper and lower surfaces of the first stack so as to prevent a crack occurring inside the first stack from spreading to an edge portion of the first stack to cause an edge crack.

2. The multilayered ceramic substrate of claim 1, further comprising a third stack formed of ceramic green sheets having a third thermal expansion coefficient different from the first thermal expansion coefficient, the third stack stacked on the other one of the upper and lower surfaces of the first stack.

3. The multilayered ceramic substrate of claim 1, wherein the first stack has a thermal expansion coefficient greater than a thermal expansion coefficient of the second stack.

4. The multilayered ceramic substrate of claim 2, wherein the first stack has a thermal expansion coefficient greater than a thermal expansion coefficient of the third stack.

5. The multilayered ceramic substrate of claim 2, wherein the second thermal expansion coefficient of the second stack is substantially identical to the third thermal expansion coefficient of the third stack.

6. The multilayered ceramic substrate of claim 1, wherein the buffer part comprises a groove provided in the at least one of the upper and lower surfaces of the first stack to induce crack occurrence.

7. The multilayered ceramic substrate of claim 6, wherein the groove is formed inside an outer periphery of the first stack.

8. The multilayered ceramic substrate of claim 1, wherein the buffer part has a thermal expansion coefficient identical to the first thermal expansion coefficient, and includes an auxiliary layer stacked on the at least one of the upper and lower surfaces of the first stack.

9. The multilayered ceramic substrate of claim 8, wherein the buffer part comprises a groove defined by a stack of the auxiliary layer to prevent crack occurrence.

10. The multilayered ceramic substrate of claim 8, wherein the auxiliary layer comprises at least one of the ceramic green sheets of the first stack.

11. The multilayered ceramic substrate of claim 9, wherein the groove is formed inside an outer periphery of the first stack.

12. The multilayered ceramic substrate of claim 1, wherein the buffer part comprises a step formed such that the edge portion of the first stack has a thickness greater than an inner portion thereof.

13. The multilayered ceramic substrate of claim 1, wherein the buffer part comprises a groove formed in the at least one of the upper and lower surfaces of the first stack to induce crack occurrence, and a step formed such that the edge portion of the first stack has a thickness greater than an inner portion thereof.

14. The multilayered ceramic substrate of claim 13, wherein the groove is formed inside the edge portion of the first stack where the step is formed.
